(19) United States
(12) Patent Application Publication
(10) Pub. No.: US 2024/0001788 A1
(43) Pub. Date: Jan. 4, 2024

(54) CHARGER, SOFT-START METHOD, ELECTRIC VEHICLE, AND CHARGING SYSTEM

(71) Applicant: Huawei Digital Power Technologies Co., Ltd., Shenzhen (CN)

(72) Inventors: Yang CHENG, Xi’an (CN); Feng SU, Shenzhen (CN); Yu MA, Shenzhen (CN)

(73) Assignee: Huawei Digital Power Technologies Co., Ltd., Shenzhen (CN)

(21) Appl. No.: 18/467,801

(22) Filed: Sep. 15, 2023

Related U.S. Application Data
(63) Continuation of application No. PCT/CN2021/091404, filed on Apr. 30, 2021.

(51) Int. Cl. B60L 53/22; B60L 53/66; B60L 53/62; B60L 50/60

(52) U.S. Cl. CPC B60L 53/22; B60L 53/66; B60L 2210/30; B60L 50/60; B60L 2210/10; B60L 53/62

(57) ABSTRACT

A charger, a soft-start method, an electric vehicle, and a charging system. The charger includes a control module, a DC-DC conversion circuit, and a first capacitor. When the electric vehicle is charged, the control module in the charger may first control the DC-DC conversion circuit to charge the first capacitor by using battery electric energy output by a battery system, and after determining that a capacitance voltage of the first capacitor reaches a first threshold voltage, indicate a charging pile to output charging electric energy. A soft-start circuit does not need to be disposed in a soft-start process of the charger, which helps simplify a circuit of the charger and implement a miniaturization design of the charger.

### CROSS-REFERENCE TO RELATED APPLICATIONS

This application is a continuation of International Application No. PCT/CN2021/091404, filed on Apr. 30, 2021, the disclosure of which is hereby incorporated by reference in its entirety.

### TECHNICAL FIELD

The embodiments relate to the field of electric vehicle technologies, a charger, a soft-start method, an electric vehicle, and a charging system.

### BACKGROUND

With development of new energy technologies, electric vehicles have received increasingly extensive attention. An on-board charger (OBC) and a power battery are disposed in the electric vehicle. The OBC may receive charging electric energy provided by a charging pile, and convert a voltage of the charging electric energy, so that a converted voltage of the charging electric energy can adapt to the power battery. Further, the power battery may receive and store the charging electric energy converted by the OBC. For the electric vehicle in motion, the power battery may release the stored charging electric energy, to provide an energy source for the electric vehicle in motion.

A bus capacitor may be disposed in the OBC and the bus capacitor may filter the charging electric energy transmitted in the OBC. Due to the existence of the bus capacitor, a large instantaneous current is directly input to the bus capacitor at a moment when the OBC and the charging pile start to work. The instantaneous current may damage the OBC. Therefore, a soft-start circuit is further disposed in each of most OBCs, to reduce an access current between the OBC and the charging pile.

However, disposing the soft-start circuit in the OBC increases circuit complexity of the OBC, and is not conducive to miniaturization of the OBC. Therefore, a soft-start solution between the charging pile and the OBC needs to be further studied.

### SUMMARY

The embodiments may provide a charger, a soft-start method, an electric vehicle, and a charging system. The charger can implement the soft-start method without disposing a soft-start circuit, which helps simplify a circuit structure of the charger, and further facilitates miniaturization of the charger.

According to a first aspect, the embodiments may provide a charger, including a control module, a direct current-direct current DC-DC conversion circuit, and a first capacitor. A first high potential end and a first low potential end of the DC-DC conversion circuit may receive charging electric energy, and a second high potential end and a second low potential end of the DC-DC conversion circuit may be connected to a battery system; and one end of the first capacitor is connected to the first high potential end of the DC-DC conversion circuit, and a second end of the first capacitor is connected to the first low potential end of the DC-DC conversion circuit. The first capacitor may alternatively be referred to as a bus capacitor. In a soft-start process, the control module may first control the DC-DC conversion circuit to charge the first capacitor by using battery electric energy output by the battery system; and send first indication information to a charging pile after a capacitance voltage of the first capacitor reaches a first threshold voltage, where the first indication information may indicate the charging pile to output the charging electric energy.

For example, the charger may be an OBC in an electric vehicle. Before receiving the charging electric energy output by the charging pile, the charger may precharge the first capacitor by using the battery electric energy provided by the battery system, so that the capacitance voltage of the first capacitor reaches a voltage that is close to the charging electric energy input to the DC-DC conversion circuit. In this case, the charger indicates the charging pile to start charging. Because the capacitance voltage of the first capacitor has been precharged to the first threshold voltage, the capacitance voltage of the first capacitor is closer to the voltage of the charging electric energy input to the DC-DC conversion circuit. Therefore, at the moment of starting charging, an instantaneous current flowing into the first capacitor is suppressed, which helps protect the charger. A soft-start circuit does not need to be disposed in the soft-start process of the charger, which helps simplify a circuit of the charger, and further facilitates miniaturization of the charger.

The first threshold voltage may be any voltage within a rated input voltage range between the first high potential end and the first low potential end of the DC-DC conversion circuit. The charger may support alternating current charging electric energy or may support direct current charging electric energy. Details are as follows:

In a possible implementation, the charging electric energy output by the charging pile is alternating current electric energy. In this case, the charger may further include a rectifier circuit, one end of the rectifier circuit is configured to receive the charging electric energy output by the charging pile, and the other end of the rectifier circuit is connected to the DC-DC conversion circuit. The rectifier circuit may convert the received charging electric energy from the alternating current electric energy into direct current electric energy and output the converted charging electric energy to the DC-DC conversion circuit.

The rectifier circuit is disposed to rectify the charging electric energy output by the charging pile, so that the charger can charge the battery in the battery system by using the alternating current charging electric energy. Currently, common alternating current electric energy may include a single-phase alternating current and a three-phase alternating current. For example, when the charging electric energy output by the charging pile is a single-phase alternating current, the first threshold voltage is greater than or equal to a peak voltage of the charging electric energy output by the charging pile. An uncontrolled rectifier voltage of the rectifier circuit for the single-phase alternating current is a peak voltage of the single-phase alternating current. Currently, most rectifier circuits further have a voltage boosting function. Therefore, an output voltage of the rectifier circuit may be greater than or equal to the peak voltage of the single-phase alternating current. In view of this, when the charging electric energy output by the charging pile is the single-phase alternating current, the first threshold voltage is greater than or equal to the peak voltage of the charging electric energy, which helps enable precharged voltage of the first capacitor to be closer to the output voltage of the rectifier circuit, to further reduce a value of an instantaneous current.

Similarly, when the charging electric energy output by the charging pile is a three-phase alternating current, the first threshold voltage is greater than or equal to a peak voltage of a line voltage of the charging electric energy output by the charging pile. An uncontrolled rectifier voltage of the rectifier circuit for the three-phase alternating current is a peak voltage of a line voltage of the three-phase alternating current. When the charging electric energy output by the charging pile is the three-phase alternating current, the first threshold voltage is greater than or equal to the peak voltage of the line voltage of the charging electric energy, which helps enable the precharged voltage of the first capacitor to be closer to the output voltage of the rectifier circuit, to further reduce the value of the instantaneous current.

In another possible implementation, the charging electric energy output by the charging pile is direct current electric energy, and in this case, the first threshold voltage is a voltage of the charging electric energy output by the charging pile. When the charging electric energy output by the charging pile is the direct current electric energy, a voltage of the first capacitor may reach an output voltage of the charging pile through precharging, which helps suppress an instantaneous current input to the first capacitor.

The charger may further include a second capacitor, one end of the second capacitor is connected to the second high potential end of the DC-DC conversion circuit, and the other end of the second capacitor is connected to the second low potential end of the DC-DC conversion circuit. When charging the battery in the battery system, the second capacitor may filter charging electric energy output by the second high potential end and the second low potential end of the DC-DC conversion circuit. When controlling the DC-DC conversion circuit to charge the first capacitor by using the battery electric energy output by the battery system, the control module may first send second indication information to the battery system, where the second indication information may indicate the battery system to output the battery electric energy to the second capacitor. When a capacitance voltage of the second capacitor reaches a second threshold voltage, the control module controls the DC-DC conversion circuit to charge the first capacitor by using the battery electric energy.

The second threshold voltage may be any voltage greater than or equal to a minimum input voltage between the second high potential end and the second low potential end of the DC-DC conversion circuit. That is, after the voltage between the second high potential end and the second low potential end reaches the second threshold voltage, the DC-DC conversion circuit may perform voltage conversion from the second high potential end to the first high potential end.

According to a second aspect, the embodiments may provide a charger soft-start method, and the method may be applied to a control module in a charger. The charger may include a direct current-direct current DC-DC conversion circuit and a first capacitor. A first high potential end and a first low potential end of the DC-DC conversion circuit may receive charging electric energy, a second high potential end and a second low potential end of the DC-DC conversion circuit may be connected to a battery system, one end of the first capacitor is connected to the first high potential end of the DC-DC conversion circuit, and a second end of the first capacitor is connected to the first low potential end of the DC-DC conversion circuit. For a corresponding solution in the second aspect, refer to the corresponding solution in the first aspect. Repeated parts are not described in detail.

For example, the charger soft-start method may include the following steps: The control module may first control the DC-DC conversion circuit to charge the first capacitor by using battery electric energy output by the battery system; and send first indication information to a charging pile after a capacitance voltage of the first capacitor reaches a first threshold voltage, where the first indication information may indicate the charging pile to output the charging electric energy.

The first threshold voltage may be any voltage within a rated input voltage range between the first high potential end and the first low potential end of the DC-DC conversion circuit. The charger may support alternating current charging electric energy or may support direct current charging electric energy. Details are as follows:

In a possible implementation, the charging electric energy output by the charging pile is alternating current electric energy. In this case, the charger may further include a rectifier circuit, one end of the rectifier circuit is configured to receive the charging electric energy output by the charging pile, and the other end of the rectifier circuit is connected to the DC-DC conversion circuit. The rectifier circuit may convert the received charging electric energy from the alternating current electric energy into direct current electric energy and output the converted charging electric energy to the DC-DC conversion circuit.

Currently, common alternating current electric energy may include a single-phase alternating current and a three-phase alternating current. For example, when the charging electric energy output by the charging pile is a single-phase alternating current, the first threshold voltage is greater than or equal to a peak voltage of the charging electric energy output by the charging pile. When the charging electric energy output by the charging pile is a three-phase alternating current, the first threshold voltage is greater than or equal to a peak voltage of a line voltage of the charging electric energy output by the charging pile.

In another possible implementation, the charging electric energy output by the charging pile is direct current electric energy, and in this case, the first threshold voltage is a voltage of the charging electric energy output by the charging pile.

The charger may further include a second capacitor, one end of the second capacitor is connected to the second high potential end of the DC-DC conversion circuit, and the other end of the second capacitor is connected to the second low potential end of the DC-DC conversion circuit. When controlling the DC-DC conversion circuit to charge the first capacitor by using the battery electric energy output by the battery system, the control module may first send second indication information to the battery system, where the second indication information may indicate the battery system to output the battery electric energy to the second capacitor. When a capacitance voltage of the second capacitor reaches a second threshold voltage, the control module controls the DC-DC conversion circuit to charge the first capacitor by using the battery electric energy.

The second threshold voltage may be any voltage greater than or equal to a minimum input voltage between the second high potential end and the second low potential end of the DC-DC conversion circuit.

According to a third aspect, the embodiments may provide an electric vehicle. The electric vehicle may include a battery system and the charger according to any one of the first aspect. The charger can charge a power battery in the battery system after completing the soft-start process.

According to a fourth aspect, the embodiments may provide a charging system. The charging system may include a charging pile and the electric vehicle according to the third aspect. As described above, the charger may send the first indication information to the charging pile after the capacitance voltage of the first capacitor reaches the first threshold voltage. The charging pile may output charging electric energy to the electric vehicle after receiving the first indication information.

These aspects are more concise and easier to understand in descriptions of the following embodiments.

### BRIEF DESCRIPTION OF THE DRAWINGS

FIG. 1 is a schematic diagram of an architecture of a charging system of an electric vehicle;

FIG. 2 is a schematic diagram of a structure of an OBC;

FIG. 3 is a schematic diagram of a structure of a PFC circuit;

FIG. 4 is a schematic diagram of a voltage change between an OBC and a charging pile in a soft-start process;

FIG. 5 is a schematic diagram of a structure of another OBC;

FIG. 6 is a schematic diagram of a structure of a charger according to an embodiment;

FIG. 7 is a schematic flowchart of a charger soft-start method according to an embodiment;

FIG. 8 is a schematic diagram of a structure of a charger according to an embodiment;

FIG. 9 is a schematic diagram of a voltage change between an OBC and a charging pile in a soft-start process according to an embodiment; and

FIG. 10 is a schematic diagram of a structure of a charger according to an embodiment.

### DETAILED DESCRIPTION OF THE EMBODIMENTS

The following further describes the embodiments in detail with reference to the accompanying drawings. A method embodiment may also be applied to an apparatus embodiment or a system embodiment. It should be noted that in the description, “at least one” means one or more, and “a plurality of” means two or more. In view of this, in the embodiments, “a plurality of” may also be understood as “at least two”. A term “and/or” describes an association relationship between associated objects and indicates that three relationships may exist. For example, A and/or B may indicate the following three cases: only A exists, both A and B exist, and only B exists. In addition, a character “/” generally indicates an “or” relationship between the associated objects unless otherwise specified. In addition, it should be understood that in the description, terms such as “first” and “second” are merely used for distinguishing and description but should not be understood as indicating or implying relative importance or should not be understood as indicating or implying a sequence.

It should be noted that a “connection” in the embodiments may be understood as an electrical connection, and the connection between two electrical elements may be a direct or indirect connection between the two electrical elements. For example, a connection between A and B may indicate that A and B are directly connected to each other, or A and B are indirectly connected to each other by using one or more other electrical elements. For example, the connection between A and B may also indicate that A is directly connected to C, C is directly connected to B, and A and B are connected to each other through C. In some scenarios, the “connection” may also be understood as coupling, for example, electromagnetic coupling between two inductors. In a word, A and B are connected, so that electric energy can be transmitted between A and B.

The following describes the embodiments with reference to accompanying the drawings.

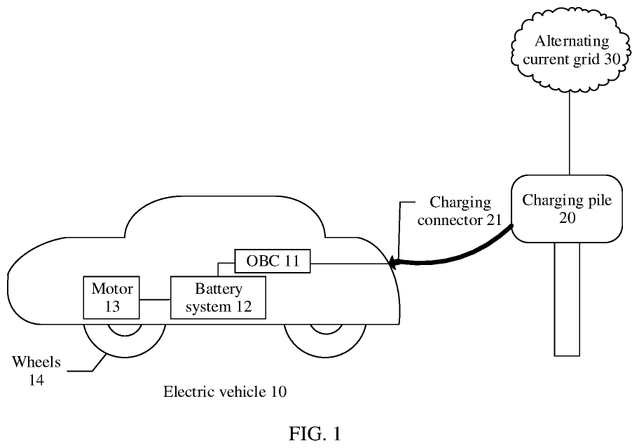

An electric vehicle is a vehicle driven by electric energy. FIG. 1 is a schematic diagram of an architecture of a charging system of an electric vehicle. As shown in FIG. 1, an electric vehicle 10 may include an on-board charger OBC 11, a battery system 12, a motor 13, and wheels 14. The battery system 12 may include a power battery with a large capacity and high power. When the electric vehicle 10 drives, the power battery may supply power to the motor 13, and the motor 13 may further drive the wheels 14 to rotate, thereby implementing movement of the vehicle.

When the electric vehicle 10 is charged, a charging pile 20 may be used to charge the electric vehicle 10. As shown in FIG. 1, the charging pile 20 includes a charging connector 21. The charging connector 21 is inserted into a charging port of the electric vehicle 10, so that the charging pile 20 is electrically connected to the OBC 11, that is, the charging pile 20 is connected to the electric vehicle 10. As shown in FIG. 1, the charging pile 20 is connected to an alternating current grid 30. After being connected to the electric vehicle 10, the charging pile 20 may provide charging electric energy for the electric vehicle 10 based on alternating current energy received from the alternating current grid 30.

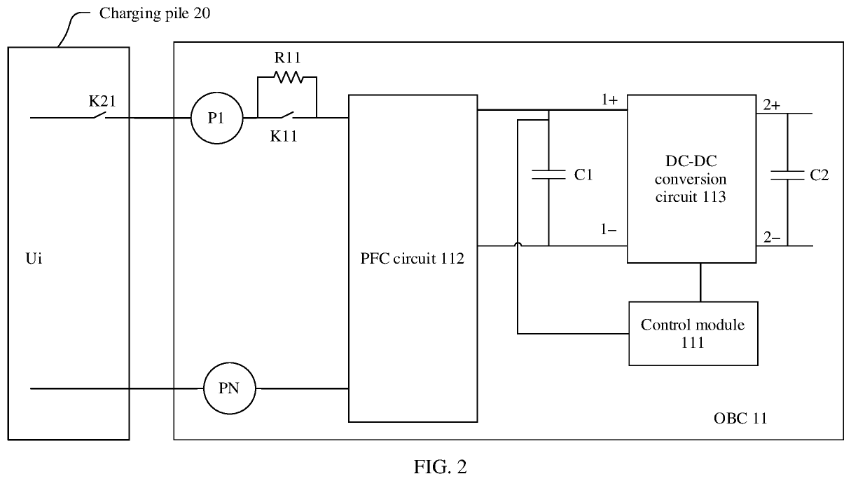

The OBC 11 may perform modulation, for example, voltage conversion and rectification, on the received charging electric energy, so that the charging electric energy can adapt to the power battery in the battery system 12. The power battery may further store charging electric energy modulated by the OBC 11. FIG. 2 is a schematic diagram of an example structure of the OBC 11. As shown in FIG. 2, the OBC 11 may include a control module 111, a power factor correction (PFC) circuit 112, and a direct current-direct current (DC-DC) conversion circuit 113.

The control module 111 is connected to the DC-DC conversion circuit 113, and the control module 111 may control the DC-DC conversion circuit 113 to work. For example, the control module 111 may be any one of a micro processing unit (MCU), a general-purpose central processing unit (CPU), a general-purpose processor, a digital signal processor (DSP), an application-specific integrated circuit (ASIC), a field programmable gate array (FPGA), or the like inside the OBC 11, or may be any one or a combination of another programmable logic device, a transistor logic device, or a hardware component.

The charging electric energy output by the charging pile 20 may be alternating current electric energy or may be direct current electric energy. For example, as shown in FIG. 2, if the charging pile 20 outputs unidirectional alternating current electric energy, the PFC circuit 112 may receive the unidirectional alternating current charging electric energy, and rectify the alternating current charging electric energy, that is, perform alternating current-direct current conversion, to obtain direct current charging electric energy. The PFC circuit 112 outputs the direct current charging electric energy to the DC-DC conversion circuit 113. The DC-DC conversion circuit 113 may perform direct current-direct current conversion on the received direct current charging electric energy under control of the control module 111, so that a voltage of the direct current charging electric energy can adapt to the power battery in the battery system 12. The DC-DC conversion circuit 113 may further output the converted charging electric energy to the power battery in the battery system 12, so that the power battery can be charged.

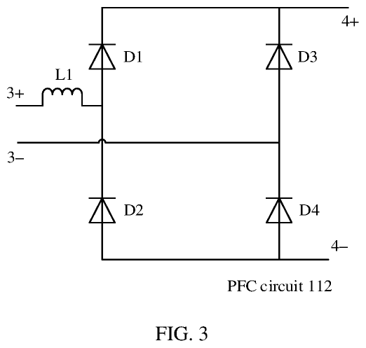

For example, the PFC circuit 112 may be an uncontrolled rectifier circuit, that is, the PFC circuit 112 includes rectifier diodes without a control function, and a rectification process of the PFC circuit 112 is not controlled by the control module 111. For example, FIG. 3 is a schematic diagram of an example structure of a PFC circuit. In this example, the PFC circuit 112 may be a bridge rectifier circuit that includes four diodes without a control function, that is, a diode D1, a diode D2, a diode D3, and a diode D4. An anode of the diode D1 is connected to a cathode of the diode D2 and is further connected to an alternating current end 3+. A cathode of the diode D1 is connected to a direct current end 4+ of the PFC circuit 112. An anode of the diode D2 is connected to a direct current end 4− of the PFC circuit 112. An anode of the diode D3 is connected to a cathode of the diode D4 and is further connected to an alternating current end 3−. A cathode of the diode D3 is connected to the direct current end 4+ of the PFC circuit 112. An anode of the diode D4 is connected to the direct current end 4− of the PFC circuit 112.

Based on the PFC circuit 112 shown in FIG. 3, when the charging electric energy received by the PFC circuit 112 is in a positive half cycle, the alternating current end 3+ is a high potential end, and the alternating current end 3− is a low potential end. In this case, the diode D1 and the diode D4 are switched on, and the diode D2 and the diode D3 are switched off, so that the direct current end 4+ is a high potential end, and the direct current end 4− is a low potential end. When the charging electric energy received by the PFC circuit 112 is in a negative half cycle, the alternating current end 3+ is a low potential end, and the alternating current end 3− is a high potential end. In this case, the diode D2 and the diode D3 are switched on, and the diode D1 and the diode D4 are switched off, so that the direct current end 4+ is a high potential end, and the direct current end 4− is a low potential end. It can be understood that, regardless of whether the charging electric energy received by the PFC circuit 112 is in the positive half cycle or the negative half cycle, the direct current end 4+ is always the high potential end, and the direct current end 4− is always the low potential end. In other words, no reversal of a voltage direction occurs between the direct current end 4+ and the direct current end 4− of the PFC circuit 112, and the PFC circuit 112 may output the direct current electric energy.

The PFC circuit 112 may also receive the direct current charging electric energy. In this case, the PFC circuit 112 may directly output the received direct current charging electric energy. For example, still refer to FIG. 2 and FIG. 3. If the charging electric energy output by the charging pile 20 is the direct current electric energy, the alternating current end 3+ is always the high potential end, and the alternating current end 3− is always the low potential end, so that the diode D1 and the diode D4 always remain switched on, and the diode D2 and diode D3 always remain switched off. In this way, the direct current end 4+ is always the high potential end, and the direct current end 4− is always the low potential end. The PFC circuit 112 may directly output the received direct current charging electric energy to the DC-DC conversion circuit 113.

It should be understood that the foregoing PFC circuit 112 being the uncontrolled rectifier circuit is merely an example for description. In some scenarios, the PFC circuit 112 may alternatively be a controllable rectifier circuit, that is, the PFC circuit 112 may alternatively include switching transistors having a control function, for example, a bridge rectifier circuit including four switching transistors. In this case, a rectifier function of the PFC circuit 112 may be implemented by controlling switch-on and switch-off of the switching transistors by the control module 111, and the switch-on and switch-off of the switching transistors may be synchronized with the switch-on and switch-off of the diodes in the foregoing example. That is, the switching transistors may implement the functions the diodes in FIG. 3 under the control of the control module 111, so that the PFC circuit 112 can rectify the received alternating current electric energy.

It should be understood that an implementation of the PFC circuit 112 is not limited in this embodiment. For example, as shown in FIG. 3, the PFC circuit 112 may further include a boost inductor L1, so that the PFC circuit 112 may further implement voltage boosting while implementing the rectification. For an implementation, refer to the conventional technology, and details are not described again in this embodiment.

As shown in FIG. 2, a capacitor C1 is further disposed between the PFC circuit 112 and the DC-DC conversion circuit 113, and the capacitor C1 may also be referred to as a bus capacitor. One end of the capacitor C1 may be connected to a high potential end 1+ of the DC-DC conversion circuit 113 and the other end of the capacitor C1 may be connected to a low potential end 1− of the DC-DC conversion circuit 113. The capacitor C1 may filter the direct current charging electric energy received by the DC-DC conversion circuit 113, to reduce a loss of the DC-DC conversion circuit 113.

As shown in FIG. 2, the OBC 11 includes a port P1 and a port PN. The port P1 is configured to connect to a live wire of the charging pile 20, and the port PN is configured to connect to a neutral wire of the charging pile 20. Therefore, the OBC 11 may receive, through the port P1 and the port PN, the charging electric energy output by the charging pile 20. The charging electric energy may be a single-phase alternating current. In a mains supply in China, a peak voltage of the single-phase alternating current may reach 311 V. However, due to the existence of the capacitor C1, at the moment when the charging pile 20 outputs the charging electric energy, a large instantaneous current is input from the port P1 because a voltage of the capacitor C1 is low, that is, a voltage difference between the direct current end and the alternating current end of the PFC circuit 112 is large. After being transmitted by the PFC circuit 112, the instantaneous current charges the capacitor C1. That is, at the moment when the charging pile 20 starts to charge the electric vehicle 10, the large instantaneous current is input to the OBC 11. It may be understood that if the instantaneous current between the charging pile 20 and the OBC 11 is excessively large, the OBC 11 may be damaged. Therefore, currently, the charging may be started between the charging pile 20 and the OBC 11 in a soft-start process.

For example, as shown in FIG. 2, a soft-start circuit is disposed in the OBC 11. The soft-start circuit may include a switch K11 and a resistor R11. A first end of the switch K11 is connected to the port P1, and a second end of the switch K11 is connected to the PFC circuit 112. A resistor R11 is connected in parallel between the first end and the second end of the switch K11. It should be noted that a control end of the switch K11 may further be connected to the control module 111. To simplify the accompanying drawings, a connection manner is not shown in this embodiment.

Correspondingly, the charging pile 20 may further include a switch K21. The switch K21 is disposed on the live wire of the charging pile 20. When the charging pile 20 is switched on, the charging pile 20 may output the charging electric energy. When the switch K21 is switched off, the charging pile 20 cannot output the charging electric energy.

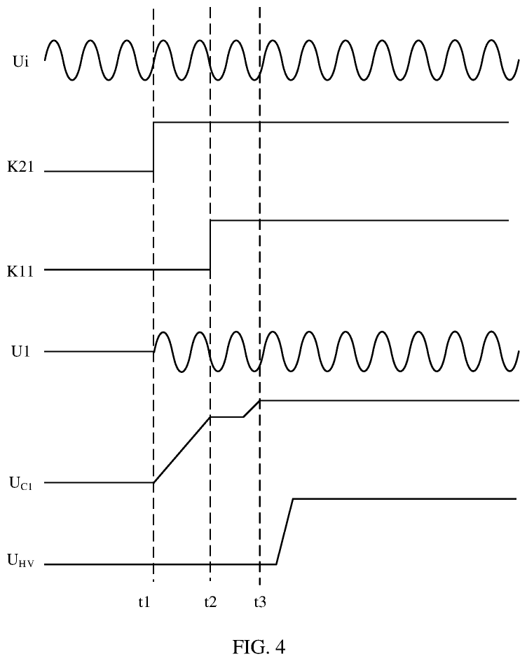

FIG. 4 is a schematic diagram of an example of a voltage change between the OBC 11 and the charging pile 20 in a soft-start process. Ui indicates a voltage of charging electric energy that can be output by the charging pile 20, and the voltage of the charging electric energy is a single-phase sine wave. It should be noted that an output voltage of the charging pile 20 is not exactly the same as Ui. When the switch K21 is switched on, the charging pile 20 may output the charging electric energy to the OBC 11. Therefore, the output voltage of the charging pile 20 may be Ui. When the switch K21 is switched off, the charging pile 20 cannot output the charging electric energy to the OBC 11. Therefore, the output voltage of the charging pile 20 may be 0.

Further, still refer to FIG. 2 and FIG. 4. A rising edge of a line K21 in FIG. 4 indicates that the switch K21 in FIG. 2 is switched on, a rising edge of a line K1 in FIG. 4 indicates that the switch K11 in FIG. 2 is switched on, a line U1 in FIG. 4 corresponds to a voltage change line of the charging electric energy received by the PFC circuit 112 in FIG. 2, that is, a change line of an input voltage of the PFC circuit 112, a line U_{C1} in FIG. 4 corresponds to a voltage change line of the capacitor C1 in FIG. 2, and a line U_{HV} in FIG. 4 corresponds to a voltage change line of a capacitor C2 in FIG. 2. One end of the capacitor C2 is connected to a high potential end 2+ of the DC-DC conversion circuit 113, and the other end of the capacitor C2 is connected to a low potential end 2− of the DC-DC conversion circuit 113. The capacitor C2 may filter the direct current charging electric energy output by the DC-DC conversion circuit 113 to the power battery.

As shown in FIG. 4, the soft-start process may include the following three time points:

Time Point t1:

The switch K21 is switched on, and the switch K11 remains switched off. Because the switch K21 is switched on, the charging pile 20 may output the alternating current charging electric energy to the OBC 11, so that the input voltage U1 of the PFC circuit 112 synchronously changes to a sine wave. Because the switch K11 remains switched off, after being transmitted through the resistor R11 and the PFC circuit 112, the instantaneous current input to the OBC 11 is input to the capacitor C1, so that the voltage U_{C1} of the capacitor C1 gradually increases. Due to a current limiting function of the resistor R11, the resistor R11 can reduce a value of the instantaneous current, thereby helping protect the OBC 11.

Time Point t2:

In the soft-start process, the control module 111 may detect the voltage U_{C1} of the capacitor C1, and switch on the switch K11 when the U_{C1} reaches a first threshold voltage. It is assumed that U_{C1} reaches the first threshold voltage at the time point t2, and the control module 111 may switch on the switch K11 at the time point t2. Because the voltage U_{C1} of the capacitor C1 reaches the first threshold voltage, the voltage difference between the alternating current end and the direct current end of the PFC circuit 112 is small. In this case, even if the switch K11 is switched on, no large instantaneous current is generated. In addition, after the switch K11 is switched on, the resistor R11 is short-circuited, that is, the PFC circuit 112 may receive, by using the switch K11, the charging electric energy provided by the charging pile 20.

The first threshold voltage may be any voltage within a rated input voltage range between the high potential end 1+ and the low potential end 1− of the DC-DC conversion circuit 113. For example, the first threshold voltage may alternatively be any voltage not lower than an uncontrolled rectifier voltage of the PFC circuit 112. When the charging electric energy received by the PFC circuit 112 is a single-phase alternating current, the uncontrolled rectifier voltage of the PFC circuit 112 may be understood as a peak voltage of the single-phase alternating current. For example, for a single-phase alternating current with a valid voltage of 220 V, the uncontrolled rectifier voltage of the PFC circuit 112 is 310 V. When the charging electric energy received by the PFC circuit 112 is a three-phase alternating current, the uncontrolled rectifier voltage of the PFC circuit 112 may be understood as a peak voltage of a line voltage of the three-phase alternating current. For example, for a three-phase alternating current with a valid voltage of 220 V, the uncontrolled rectifier voltage of the PFC circuit 112 is 658 V.

After the time point t2, the PFC circuit 112 may start rectifying the received alternating current electric energy. As shown in FIG. 4, after the time point t2, the voltage U_{C1} of the capacitor C1 remains unchanged for a period of time, and the period of time may be understood as a delay in starting the rectification by the PFC circuit 112.

In some PFC circuits 112, as shown in FIG. 3, the PFC circuit 112 may further be compatible with a boost (boost) circuit (that is, including a boost inductor L1). The boost circuit may cause an actual output voltage of the PFC circuit 112 to be greater than the uncontrolled rectifier voltage of the PFC circuit 112. Therefore, as shown in FIG. 4, after the PFC circuit 112 starts the rectification, the PFC circuit 112 may output the direct current charging electric energy, so that the voltage U_{C1} of the capacitor C1 is further increased.

Time Point t3:

After the voltage U_{C1} of the capacitor C1 reaches a third threshold voltage, the control module 111 may control the DC-DC conversion circuit 113 to start working. It is assumed that the voltage U_{C1} of the capacitor C1 reaches the third threshold voltage at the time point t3, and the control module 111 may control the DC-DC conversion circuit 113 to start working at the time point t3.

The third threshold voltage may be a voltage adapting to a target output voltage of the DC-DC conversion circuit 113, that is, the DC-DC conversion circuit 113 may convert the third threshold voltage into the target output voltage. For example, it is assumed that the power battery may receive 800 V charging electric energy, and the target output voltage of the DC-DC conversion circuit 113 may be 800 V. In this case, if a transformation ratio of the DC-DC conversion circuit 113 is 2, the third threshold voltage may be 400 V. Therefore, when the voltage U_{C1} of the capacitor C1 reaches 400 V, the DC-DC conversion circuit 113 can convert the voltage of the charging electric energy from 400 V to 800 V adapting to the power battery.

As shown in FIG. 4, after the time point t3, the voltage U_{HV} of the capacitor C2 remains unchanged for a period of time, and the period of time may be understood as a delay in starting the voltage conversion by the DC-DC conversion circuit 113. After the DC-DC conversion circuit 113 starts the voltage conversion, the DC-DC conversion circuit 113 may output the direct current charging electric energy, so that the voltage U_{HV} of the capacitor C2 is rapidly increased until the voltage adapting to the power battery is reached.

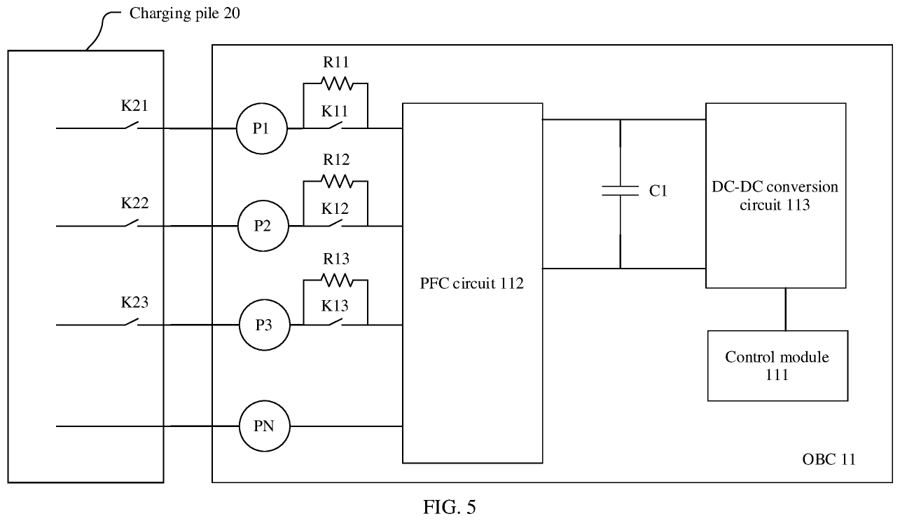

It can be understood that, by disposing the soft-start circuit in the OBC 11, a soft-start process can be implemented between the charging pile 20 and the OBC 11. However, the disposing of the soft-start circuit also increases complexity of a circuit structure of the OBC 11. In a three-phase charging scenario, a quantity of components and an occupied board area of the slow-start circuit in the OBC 11, and complexity of a circuit structure of the OBC 11 may further increase. As shown in FIG. 5, in a three-phase charging scenario, the OBC 11 includes the port P1, a port P2, and a port P3. Correspondingly, the charging pile 20 includes the switch K21, a switch K22, and a switch K23. In the OBC 11, the port P1 is connected to a soft-start circuit including the switch K11 and the resistor R11, the port P2 is connected to a soft-start circuit including a switch K12 and a resistor R12, and the port P3 is connected to a soft-start circuit including a switch K13 and a resistor R13. Compared with the single-phase electric charging scenario shown in FIG. 2, a quantity of components and an occupied board area of the slow-start circuits in the OBC 11, and complexity of a circuit structure of the OBC 11 in the three-phase charging scenario further increase.

By disposing the soft-start circuit in the OBC 11, a soft-start process can be implemented between the OBC 11 and the charging pile 20, but this is not conducive to miniaturization of the OBC 11. In view of this, an embodiment may provide a charger. The charger may be used as the OBC 11 in the electric vehicle 10 or may be applied to another type of battery charging system (for example, a photovoltaic system using a solar storage architecture). This is not limited in this embodiment. That the charger is used as the OBC 11 in the electric vehicle 10 is used as an example. In this embodiment, the soft-start circuit does not need to be disposed in the charger, so that the soft-start process can be implemented between the charger and the charging pile 20, thereby facilitating miniaturization of the charger.

Next, the charger provided in this embodiment is further described by using an example based on a type of charging electric energy output by the charging pile 20.

Scenario 1: The charging pile 20 outputs direct current charging electric energy.

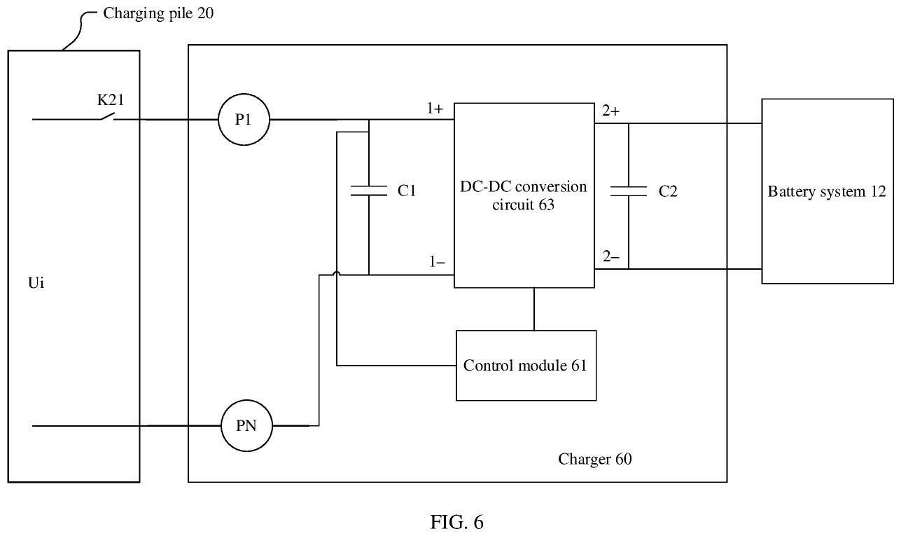

For example, as shown in FIG. 6, the charger 60 provided in this embodiment may include a control module 61, a DC-DC conversion circuit 63, and a capacitor C1. A high potential end 1+ of the DC-DC conversion circuit 63 is connected to a port P1 of the charger and a low potential end 1− of the DC-DC conversion circuit 63 is connected to a port PN of the charger 60. In a charging process, the port P1 and the port PN may be connected to the charging pile 20. Therefore, the DC-DC conversion circuit 63 may receive, through the high potential end 1+ and the low potential end 1−, the charging electric energy output by the charging pile 20, and the charging electric energy is the direct current electric energy.

One end of the capacitor C1 is connected to the high potential end 1+ of the DC-DC conversion circuit 63, and the other end of the capacitor C1 is connected to the low potential end 1− of the DC-DC conversion circuit 63. The capacitor C1 may filter the direct current electric energy input to the DC-DC conversion circuit 63.

The control module 61 may further control the DC-DC conversion circuit 63 to perform voltage conversion. A high potential end 2+ and a low potential end 2− of the DC-DC conversion circuit 63 are respectively connected to a battery system 12. The battery system 12 includes a power battery, and the DC-DC conversion circuit 63 performs the voltage conversion on the charging electric energy, so that a voltage of the charging energy can adapt to the battery system 12. For an implementation process, refer to the conventional technology, and details are not described herein again.

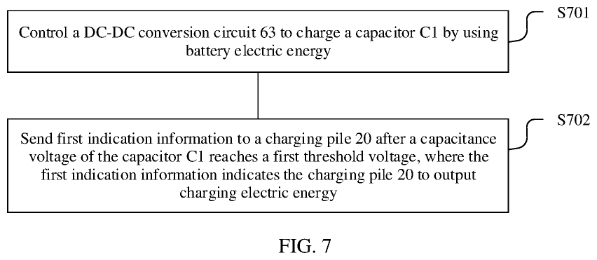

As described above, the capacitor C1 is one of main factors that cause an excessively large instantaneous current at the start of charging. To implement the soft-start process, the control module 61 in this embodiment may perform a method shown in FIG. 7 after the charging pile 20 is connected to the charger 60. As shown in FIG. 7, the method may include the following steps:

S701: The control module 61 controls the DC-DC conversion circuit 63 to charge the capacitor C1 by using battery electric energy output by the battery system 12.

As shown in FIG. 6, the high potential end 2+ and the low potential end 2− of the DC-DC conversion circuit 63 may be connected to the battery system 12. Therefore, the control module 61 may control the DC-DC conversion circuit 63 to receive the battery electric energy output by the battery system 12.

It should be noted that the battery system 12 may include a plurality of types of batteries. For example, the battery system 12 may include the power battery, and the power battery may be configured to supply power to the motor 13 in the electric vehicle 10 shown in FIG. 1. The battery system 12 may also include a low-voltage battery. The low-voltage battery may be configured to supply power to a low-voltage load (such as a vehicle audio or an intelligent cockpit) in the electric vehicle 10. A source of battery electric energy provided by the battery system 12 is not limited in this embodiment. For example, the battery electric energy received by the DC-DC conversion circuit 63 may come from both the power battery in the battery system 12 and the low-voltage battery in the battery system 12.

In a possible implementation, before performing S701, the control module 61 may further send second indication information to the battery system 12. After receiving the second indication information, the battery system 12 may output the battery electric energy to the DC-DC conversion circuit 63.

S702: Send first indication information to the charging pile 20 after a capacitance voltage of the capacitor C1 reaches a first threshold voltage, where the first indication information indicates the charging pile 20 to output the charging electric energy.

The first threshold voltage may be any voltage within a rated input voltage range between the high potential end 1+ and the low potential end 1− of the DC-DC conversion circuit 63. For example, if the high potential end 1+ and the low potential end 1− of the DC-DC conversion circuit 63 may support a voltage of 400 V to 800 V, the first threshold voltage may be any voltage within 400 V to 800 V.

For example, when the charging electric energy received by the charger 60 is direct current electric energy, the first threshold voltage may be a voltage of the direct current electric energy. As the DC-DC conversion circuit 63 charges the capacitor C1, the capacitance voltage of the capacitor C1 gradually increases. After the capacitance voltage of the capacitor C1 reaches the first threshold voltage, it means that a difference between the capacitance voltage of the capacitor C1 and an output voltage Ui of the charging pile 20 is small.

In this case, the control module 61 sends the first indication information to the charging pile 20. After receiving the first indication information, the charging pile 20 may switch on the switch K21, to output the charging electric energy to the charger 60. Since the difference between the voltage Ui of the charging electric energy and the capacitance voltage of the capacitor C1 is small, the instantaneous current generated at the moment when the charging is started (the switch K21 is switched on) is small, thereby facilitating protection of the charger 60.

It should be noted that a sending manner of the first indication information is not limited in this embodiment. For example, the control module 61 may establish a wired connection to the charging pile 20, to transmit the first indication information in a wired manner. The charger 60 may alternatively send the first indication information to the charging pile 20 in a wireless manner by using a wireless transmission module in the electric vehicle and wireless transmission technologies such as Bluetooth, wireless broadband (Wi-Fi), a Zigbee protocol, a radio frequency identification (RFID) technology, and a near field communication (NFC) technology. These are not enumerated one by one in this embodiment.

It can be understood that, before receiving the charging electric energy output by the charging pile 20, the charger 60 may precharge the capacitor C1 by using the battery electric energy provided by the battery system 12, so that the capacitance voltage of the capacitor C1 reaches a voltage that is close to the voltage (in one scenario, it may also be understood as a voltage that is close to the output voltage of the charging pile 20) of the charging electric energy input to the DC-DC conversion circuit 63. In this case, the charger indicates the charging pile 20 to start charging. Since the capacitance voltage of the capacitor C1 is close to the output voltage of the charging pile 20, the instantaneous current generated at the moment when the charging is started is small, thereby facilitating the protection of the charger 60. In this process, a soft-start circuit does not need to be disposed in the charger 60, thereby facilitating miniaturization design of the charger 60.

Scenario 2: The charging pile 20 outputs single-phase alternating current charging electric energy.

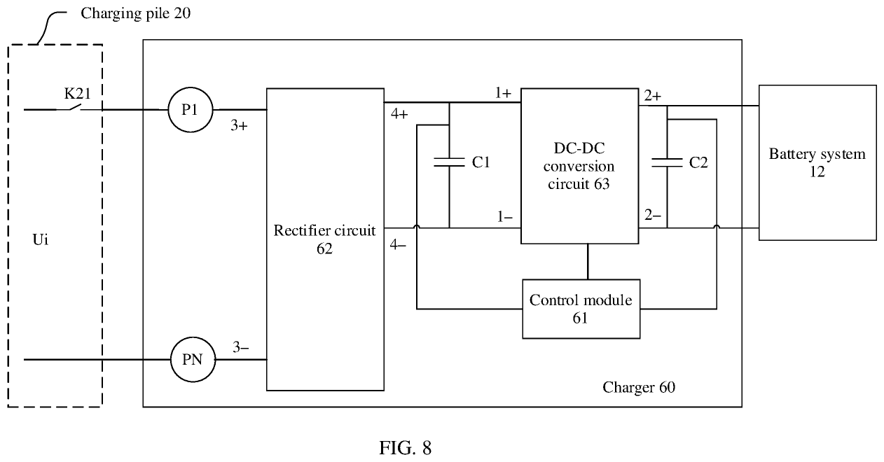

In the current market, some charging piles 20 can output the single-phase alternating current charging electric energy. To adapt to this scenario, in a possible implementation, as shown in FIG. 8, the charger 60 may further include a rectifier circuit 62. For example, the rectifier circuit 62 may be a PFC circuit, and implementation details are not described again.

An alternating current end 3+ of the rectifier circuit 62 is connected to the port P1, and an alternating current end 3− of the rectifier circuit 62 is connected to the port PN. The rectifier circuit 62 may receive the single-phase alternating current charging electric energy through the alternating current end 3+ and the alternating current end 3−. The rectifier circuit 62 rectifies the received single-phase alternating current charging electric energy, to obtain direct current charging electric energy. The rectifier circuit 62 may further output the direct current charging electric energy to the DC-DC conversion circuit 63, and the DC-DC conversion circuit 63 further performs voltage conversion on the direct current charging electric energy, to obtain direct current charging electric energy that adapts to a voltage of the power battery in the battery system 12.

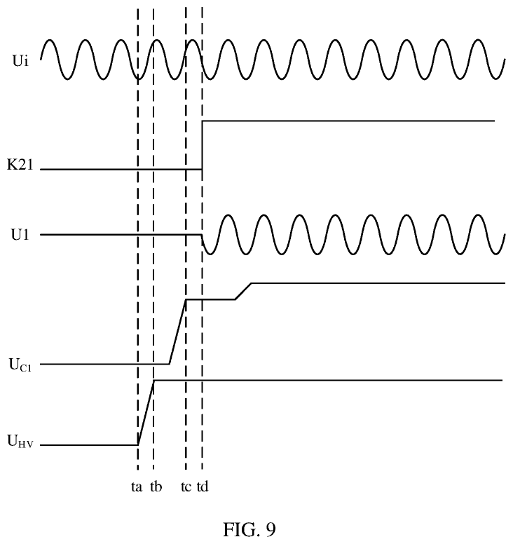

Next, based on the charger 60 shown in FIG. 8, a soft-start process applicable to this embodiment is further described by using an example. FIG. 9 is a schematic diagram of an example of a voltage change between the charger 60 and the charging pile 20 in the soft-start process according to an embodiment. As shown in FIG. 9 and FIG. 8, the following four time points may be included:

Time Point ta:

The control module 61 may send second indication information to the battery system 12, and indicate, by using the second indication information, the battery system 12 to output battery electric energy to the DC-DC conversion circuit 63. For an implementation process, refer to Scenario 1, and details are not described herein again.

As the battery system 12 outputs the battery electric energy, a capacitor C2 is continuously charged to gradually increase a voltage U_{HV} of the capacitor C2.

Time Point tb:

After the voltage U_{HV} of the capacitor C2 reaches a second threshold voltage, the control module 61 may control the DC-DC conversion circuit 63 to charge the capacitor C1. The second threshold voltage may be any voltage greater than or equal to a minimum input voltage between the high potential end 2+ and the low potential end 2− of the DC-DC conversion circuit 63. That is, after the voltage between the high potential end 2+ and the low potential end 2− reaches the second threshold voltage, the DC-DC conversion circuit 63 may perform voltage conversion from the battery system 12 to the rectifier circuit 62.

The control module 61 may detect the voltage of the capacitor C2. It is assumed that the voltage U_{HV} of the capacitor C2 reaches the second threshold voltage at the time point tb. The control module 61 may further control the DC-DC conversion circuit 63 to charge the capacitor C1 by using the received battery electric energy, so that a voltage U_{C1} of the capacitor C1 gradually increases.

The control module 61 may control the DC-DC conversion circuit 63 to perform boost conversion on the battery electric energy or may control the DC-DC conversion circuit 63 to perform buck conversion on the battery electric energy. This is not limited in this embodiment. As shown in FIG. 9, after a delay after the time point tb, the voltage U_{C1} of the capacitor C1 gradually starts to increase, and the delay may be understood as a delay required by DC-DC conversion circuit 63 to start the voltage conversion.

Time Point tc:

The control module 61 may detect the voltage U_{C1} of the capacitor C1 until U_{C1} reaches a first threshold voltage. When the charging electric energy received by the charger 60 is the single-phase alternating current, the first threshold voltage may be any voltage greater than or equal to a peak voltage of the single-phase alternating current. For example, if the charging electric energy is a single-phase alternating current with a valid voltage of 220 V, the first threshold voltage may be a voltage greater than or equal to 310 V.

It is assumed that U_{C1} reaches the first threshold voltage at the time point tc, the control module 61 may send first indication information to the charging pile 20.

Time Point td:

If the charging pile 20 receives the first indication information at the time point td, the charging pile 20 may switch on the switch K21 based on the first indication information, to output the charging electric energy to the charger 60, and an input voltage U1 of the rectifier circuit 62 changes to a voltage Ui of the charging electric energy. At this point, the soft-start process between the charging pile 20 and the charger 60 is completed.

After receiving the charging electric energy, the rectifier circuit 62 may rectify the charging electric energy. The rectifier circuit 62 may have a voltage boosting function, that is, an output voltage at a direct current end of the rectifier circuit 62 may be greater than the peak voltage of the single-phase alternating current. As described above, the first threshold voltage in this embodiment is greater than or equal to the peak voltage of the single-phase alternating current. Therefore, the output voltage of the direct current end of the rectifier circuit 62 may be greater than the first threshold voltage, may be less than the first threshold voltage, or may be equal to the first threshold voltage.

When the output voltage of the direct current end of the rectifier circuit 62 is greater than the first threshold voltage, as shown in FIG. 9, the voltage U_{C1} of the capacitor C1 further increases to the output voltage of the direct current end of the rectifier circuit 62 after a delay after the time point td. The delay may be understood as a delay required by the rectifier circuit 62 to start the rectification. It may be understood that, when the output voltage of the direct current end of the rectifier circuit 62 is less than the first threshold voltage, the voltage U_{C1} of the capacitor C1 further reduces to the output voltage of the direct current end of the rectifier circuit 62 after the time point td.

Scenario 3: The charging pile 20 outputs three-phase alternating current charging electric energy.

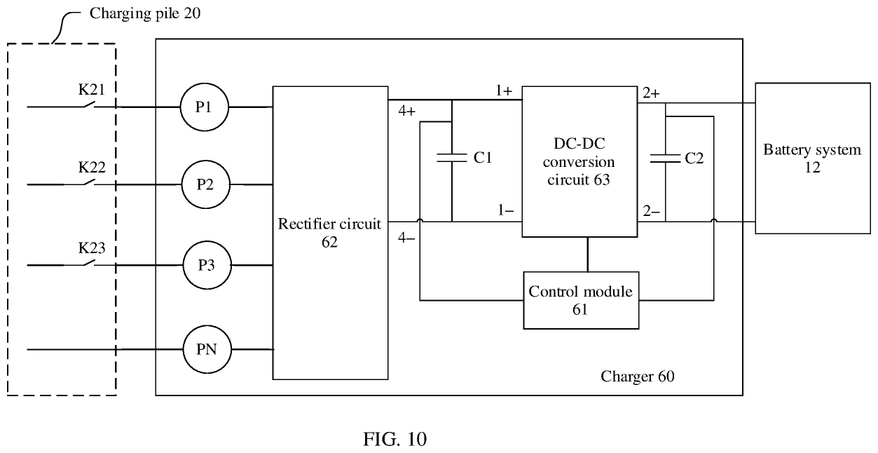

It should be noted that the charger 60 provided in this embodiment may also be applicable to the three-phase alternating current charging electric energy. For example, as shown in FIG. 10, the charger 60 includes the port P1, a port P2, a port P3, and the port PN, and all the four ports are connected to the rectifier circuit 62.

The port P1 may be correspondingly connected to the switch K21 in the charging pile 20. When the switch K21 is switched on, the port P1 may receive electricity of phase A. The port P2 may be correspondingly connected to a switch K22 in the charging pile 20. When the switch K22 is switched on, the port P2 may receive electricity of phase B. The port P3 may be correspondingly connected to a switch K23 in the charging pile 20. When the switch K23 is switched on, the port P3 may receive electricity of phase C. The port PN may be connected to a zero-phase wire in the charging pile 20 to form a loop.

A soft-start process in this scenario is similar to that in Scenario 2, and details are not described again in this embodiment. A different lies that when the charging electric energy received by the charger 60 is the three-phase alternating current, the first threshold voltage may be any voltage greater than or equal to a peak voltage of a line voltage of the three-phase alternating current. For example, if the charging electric energy is a three-phase alternating current with a valid voltage of 220 V, the first threshold voltage may be a voltage greater than or equal to 658 V.

A person skilled in the art should understand that the embodiments may be provided as a method, a system, or a computer program product. Therefore, the embodiments may use a form of hardware only embodiments, software only embodiments, or embodiments with a combination of software and hardware. In addition, the embodiments may use a form of a computer program product that is implemented on one or more non-transitory computer-usable storage media (including, but not limited to, a disk memory, a CD-ROM, an optical memory, and the like) that include computer-usable program code.

The embodiments may be described with reference to the flowcharts and/or block diagrams of the method, the device (system), and the computer program product. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a function in one or more processes in the flowcharts and/or in one or more blocks in the block diagrams.

The computer program instructions may alternatively be stored in a computer-readable memory that can indicate a computer or any other programmable data processing device to work in a manner, so that the instructions stored in the computer-readable memory generate an artifact that includes an instruction apparatus. The instruction apparatus implements a function in one or more processes in the flowcharts and/or in one or more blocks in the block diagrams.

The computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a function in one or more processes in the flowcharts and/or in one or more blocks in the block diagrams.

It is clear that a person skilled in the art can make various modifications and variations without departing from the scope of the embodiments and their equivalents.

What is claimed is:

1. A charger, comprising:
a control module;
a DC-DC conversion circuit, a first high potential end and a first low potential end of the DC-DC conversion circuit are configured to receive charging electric energy, and a second high potential end and a second low potential end of the DC-DC conversion circuit are configured to connect to a battery system; and
a first capacitor, wherein
one end of the first capacitor is connected to the first high potential end of the DC-DC conversion circuit, and a second end of the first capacitor is connected to the first low potential end of the DC-DC conversion circuit; and
the control module is configured to:
control the DC-DC conversion circuit to charge the first capacitor by using battery electric energy output by the battery system; and
send first indication information to a charging pile after a capacitance voltage of the first capacitor reaches a first threshold voltage, wherein the first indication information indicates the charging pile to output the charging electric energy.

2. The charger according to claim 1, wherein the charging electric energy output by the charging pile is alternating current electric energy;
the charger further comprises a rectifier circuit, one end of the rectifier circuit is configured to receive the charging electric energy output by the charging pile, and the other end of the rectifier circuit is connected to the DC-DC conversion circuit; and
the rectifier circuit is configured to:
convert the received charging electric energy from the alternating current electric energy into direct current electric energy, and
output the converted charging electric energy to the DC-DC conversion circuit.

3. The charger according to claim 2, wherein the charging electric energy output by the charging pile is a single-phase alternating current, and the first threshold voltage is greater than or equal to a peak voltage of the charging electric energy output by the charging pile.

4. The charger according to claim 2, wherein the charging electric energy output by the charging pile is a three-phase alternating current, and the first threshold voltage is greater than or equal to a peak voltage of a line voltage of the charging electric energy output by the charging pile.

5. The charger according to claim 1, wherein the charging electric energy output by the charging pile is direct current electric energy, and the first threshold voltage is a voltage of the charging electric energy output by the charging pile.

6. The charger according to claim 1, further comprising:
a second capacitor, wherein one end of the second capacitor is connected to the second high potential end of the DC-DC conversion circuit, and the other end of the second capacitor is connected to the second low potential end of the DC-DC conversion circuit; and
the control module is further configured to:
send second indication information to the battery system, wherein the second indication information indicates the battery system to output the battery electric energy to the second capacitor; and
when a capacitance voltage of the second capacitor reaches a second threshold voltage, control the DC-DC conversion circuit to charge the first capacitor by using the battery electric energy.

7. The charger according to claim 6, wherein the second threshold voltage is greater than or equal to a minimum input voltage between the second high potential end and the second low potential end of the DC-DC conversion circuit.

8. A charger soft-start method, applied to a control module in a charger, wherein the charger comprises a DC-DC conversion circuit and a first capacitor, a first high potential end and a first low potential end of the DC-DC conversion circuit are configured to receive charging electric energy, a second high potential end and a second low potential end of the DC-DC conversion circuit are configured to connect to a battery system, one end of the first capacitor is connected to the first high potential end of the DC-DC conversion circuit, and a second end of the first capacitor is connected to the first low potential end of the DC-DC conversion circuit; and
the method comprises:
controlling the DC-DC conversion circuit to charge the first capacitor by using battery electric energy output by the battery system; and
sending first indication information to a charging pile after a capacitance voltage of the first capacitor reaches a first threshold voltage, wherein the first indication information indicates the charging pile to output the charging electric energy.

9. The charger soft-start method according to claim 8, wherein the charging electric energy output by the charging pile is alternating current electric energy;
the charger further comprises a rectifier circuit, one end of the rectifier circuit is configured to receive the charging electric energy output by the charging pile, and the other end of the rectifier circuit is connected to the DC-DC conversion circuit; and
the rectifier circuit is configured to:
convert the received charging electric energy from the alternating current electric energy into direct current electric energy, and
output the converted charging electric energy to the DC-DC conversion circuit.

10. The charger soft-start method according to claim 9, wherein the charging electric energy output by the charging pile is a single-phase alternating current, and the first threshold voltage is greater than or equal to a peak voltage of the charging electric energy output by the charging pile.

11. The charger soft-start method according to claim 9, wherein the charging electric energy output by the charging pile is a three-phase alternating current, and the first threshold voltage is greater than or equal to a peak voltage of a line voltage of the charging electric energy output by the charging pile.

12. The charger soft-start method according to claim 8, wherein the charging electric energy output by the charging pile is direct current electric energy, and the first threshold voltage is a voltage of the charging electric energy output by the charging pile.

13. The charger soft-start method according to claim 8, wherein the charger further comprises a second capacitor, one end of the second capacitor is connected to the second high potential end of the DC-DC conversion circuit, and the other end of the second capacitor is connected to the second low potential end of the DC-DC conversion circuit; and
controlling the DC-DC conversion circuit to charge the first capacitor by using the battery electric energy output by the battery system further comprises:
sending second indication information to the battery system, wherein the second indication information indicates the battery system to output the charging electric energy to the second capacitor; and
when a capacitance voltage of the second capacitor reaches a second threshold voltage, controlling the DC-DC conversion circuit to charge the first capacitor by using the battery electric energy.

14. The charger soft-start method according to claim 13, wherein the second threshold voltage is greater than or equal to a minimum input voltage between the second high potential end and the second low potential end of the DC-DC conversion circuit.

15. An electric vehicle, comprising a battery system and a charger, wherein
the charger comprises a DC-DC conversion circuit, and a first capacitor, a first high potential end and a first low potential end of the DC-DC conversion circuit are configured to receive charging electric energy, and a second high potential end and a second low potential end of the DC-DC conversion circuit are configured to connect to a battery system; and one end of the first capacitor is connected to the first high potential end of the DC-DC conversion circuit, and a second end of the first capacitor is connected to the first low potential end of the DC-DC conversion circuit;
the charger is configured to charge a power battery in the battery system.

16. The electric vehicle according to claim 15, wherein the charger comprises a control module and the control module is configured to:
control the DC-DC conversion circuit to charge the first capacitor by using battery electric energy output by the battery system; and
send first indication information to a charging pile after a capacitance voltage of the first capacitor reaches a first threshold voltage, wherein the first indication information indicates the charging pile to output the charging electric energy.

17. The electric vehicle according to claim 16, wherein the charging electric energy output by the charging pile is alternating current electric energy;
the charger further comprises a rectifier circuit, one end of the rectifier circuit is configured to receive the charging electric energy output by the charging pile, and the other end of the rectifier circuit is connected to the DC-DC conversion circuit; and
the rectifier circuit is configured to:
convert the received charging electric energy from the alternating current electric energy into direct current electric energy, and
output the converted charging electric energy to the DC-DC conversion circuit.

18. The electric vehicle according to claim 17, wherein the charging electric energy output by the charging pile is a single-phase alternating current, and the first threshold voltage is greater than or equal to a peak voltage of the charging electric energy output by the charging pile.

19. The electric vehicle according to claim 17, wherein the charging electric energy output by the charging pile is a three-phase alternating current, and the first threshold voltage is greater than or equal to a peak voltage of a line voltage of the charging electric energy output by the charging pile.

20. The electric vehicle according to claim 15, wherein the charging electric energy output by the charging pile is direct current electric energy, and the first threshold voltage is a voltage of the charging electric energy output by the charging pile.
